(19) United States
(12) Patent Application Publication
(10) Pub. No.: US 2004/0020290 A1
(43) Pub. Date: Feb. 5, 2004

(54) Wheel guard arrangement of a wheel balancing machine

(75) Inventors: Karl Rothamel, Ober-Ramstadt (DE); Josef Drechsler, Pfungstadt (DE)

Correspondence Address: OSTROLENK FABER GERB & SOFFEN, 1180 AVENUE OF THE AMERICAS, NEW YORK, NY, 100368403

(73) Assignee: Snap-on Equipment GmbH

(21) Appl. No.: 10/613,573

(22) Filed: Jul. 3, 2003

(30) Foreign Application Priority Data
Jul. 5, 2002 (DE) 102 30 359.2

(51) Int. Cl. G01M 1/16

(52) U.S. Cl. 73/460

(57) ABSTRACT

A wheel guard arrangement in a wheel balancing machine in which the wheel guard member is formed by a flexurally elastic plate which is guided on the machine housing pivotably by a frame. In the open position of the wheel guard arrangement the flexurally elastic plate is flat and positioned vertically and in the closed position it is of an arcuate configuration extending over a wheel to be balanced.

### FIELD OF THE INVENTION

The invention concerns a wheel balancing machine and more particularly a wheel guard arrangement of the machine.

### BACKGROUND OF THE INVENTION

A wheel balancing machine will usually be provided with a wheel guard arrangement to protect the machine operator. More specifically to measure unbalance of for example a motor vehicle wheel the wheel is centered non-rotatably on a main shaft of the wheel balancing machine and then accelerated up to a measuring speed. To protect the operator, before the wheel is accelerated to the measuring speed, a wheel guard member in the form of an arcuate member or a wheel guard hood is pivoted from an open position in which the arcuate wheel guard member is arranged substantially vertically to allow access to the main shaft of the wheel balancing machine, into a closed position in which the wheel guard member is disposed in a substantially horizontal condition over the main shaft and thus over the wheel fixed thereon. The wheel guard member which comprises a flexurally stiff material extends around the upwardly disposed part of the periphery of the wheel to be balanced. In that way the operator can be satisfactorily protected from pieces flying off the rotating wheel or from coming into contact with the wheel as it rotates.

The arcuately curved configuration of the wheel guard member means that such a wheel guard arrangement, when in the open position, requires space behind the balancing machine, into which the arcuate curved wheel guard member or hood can be pivoted in its open position. That therefore involves an increase in the floor area occupied by the wheel balancing machine. If the wheel balancing machine therefore is arranged in the proximity of a wall it is necessary for the machine to be arranged spaced at a suitable distance from the wall so that, when the wheel guard member is in the open condition, there is still sufficient space behind the machine to accept the curvature configuration of the wheel guard member or hood.

### SUMMARY OF THE INVENTION

An object of the invention is to provide a wheel guard arrangement of a wheel balancing machine, which is so designed as to allow a reduction in the floor area occupied by the machine.

Another object of the invention is to provide a wheel guard arrangement for a wheel balancing machine, which while being of a simple structure affords enhanced versatility of use of the machine.

Still a further object of the invention is to provide a wheel balancing machine incorporating a wheel guard arrangement which by virtue of its design configuration avoids imposing further limitations on the machine in terms of installation and operation thereof.

In accordance with the present invention the foregoing and other objects are attained by a wheel guard arrangement of a wheel balancing machine, comprising a wheel guard member and a mounting device for mounting the wheel guard member on a housing of the balancing machine movably between an open position in which the wheel guard member is arranged substantially vertically and a closed position in which the wheel guard member extends substantially horizontally over a main shaft of the machine. The wheel guard member comprises a flexurally elastic plate and a frame which is supported on the machine housing and guides the plate. The frame is movable between the open and the closed positions. In the open position the plate is of a substantially flat shape while in the closed position it is deformed in an arcuate configuration.

In accordance with a preferred feature of the invention, the flexurally elastic plate, in its longitudinal extent, can be supported on the machine housing at at least three support locations, more preferably at the pivotably mounted frame. The plate is preferably also of a resiliently flexurally elastic nature, thereby to ensure that, when the plate which is in the closed position and which is deformed to constitute the arcuate configuration of the wheel guard member is moved into the open position, the plate automatically returns to its flat or planar configuration by virtue of the resiliency thereof.

In order to move the flexurally elastic plate out of its flat or planar configuration into the arcuate configuration, more specifically in the shape of a circular arc, provided on the plate at least in the region of the two ends thereof and in a central region thereof are support locations which are preferably arranged on straight lines extending at least substantially transversely with respect to the longitudinal extent of the plate.

In a preferred feature of the invention one of the support locations is disposed in the proximity of a rearward end of the plate. Preferably the plate in that region is guided movably with a low level of friction, for example by means of rollers.

In addition, in another preferred feature, the support location disposed substantially in the central region of the plate can have one or more support members, for example in the form of rollers, on which the plate is guided movably with respect to the support location. As will be seen from the description of a preferred embodiment of the invention set forth hereinafter, the preferably low-friction, movable guidance for the plate with respect to the support location and with respect to the frame guarantees unobstructed deformation thereof into an arcuate shape when the plate is pivoted from the open, substantially vertical position into the closed, substantially horizontal position.

Preferably, the plate is fixedly connected to the frame at the front end which is in opposite relationship to the mounting device.

In another preferred feature of the invention, in the closed position of the wheel guard member, the support lines at which the arcuate plate is supported are at the corners of a triangle with a support location disposed above the main shaft, whereby, in conjunction with the flexural elasticity of the plate, that provides for the desired arcuate shape to form the arcuate member forming the wheel guard hood.

Preferably, the support location which is disposed substantially in the central region of the plate is on a support device which is mounted pivotably or fixedly to the housing, or preferably it is supported on a lever which is mounted pivotably to the housing of the machine. In the open position the lever preferably extends substantially parallel to the frame which, together with the plate when in the planar configuration, extends substantially in a vertical direction without requiring a substantial amount of space at the rear of the machine. When the lever is pivoted into the open position the angle of pivotal movement of the lever is preferably less than the angle of pivotal movement of the frame when it is pivoted to approximately the horizontal position. That ensures that the support location on the lever forms the upward tip of the triangle of the at least three support locations for the flexurally elastic plate.

In a preferred feature the plate can be formed from two or more layers. A relatively thin outwardly disposed layer of a substantially rectangular configuration can serve in that respect as a dirt catcher or for catching other pieces which fly off the wheel as it rotates in the machine. A second thicker elastic layer determines the in particular resilient flexurally elastic property of the plate. For that purpose, to determine locally different flexural moments, it is possible to adopt different widths and different dimensions for the elastic layer. In addition, the plate may preferably have diagonally extending shallow grooves which terminate in the ends of the plate. That can also provide for locally adjusting the elastic and in particular resilient bendability of the plate.

Further objects, features and advantages of the invention will be apparent from the description hereinafter of a preferred embodiment of the invention.

### BRIEF DESCRIPTION OF THE DRAWING

FIG. 1 shows a side view of a wheel balancing machine with a wheel guard arrangement in the open condition,

FIG. 2 shows the structure of FIG. 1 with the wheel guard arrangement in the closed condition, and

FIG. 3 shows a front view of the structure of FIGS. 1 and 2 with the wheel guard arrangement open.

### DESCRIPTION OF THE PREFERRED EMBODIMENT

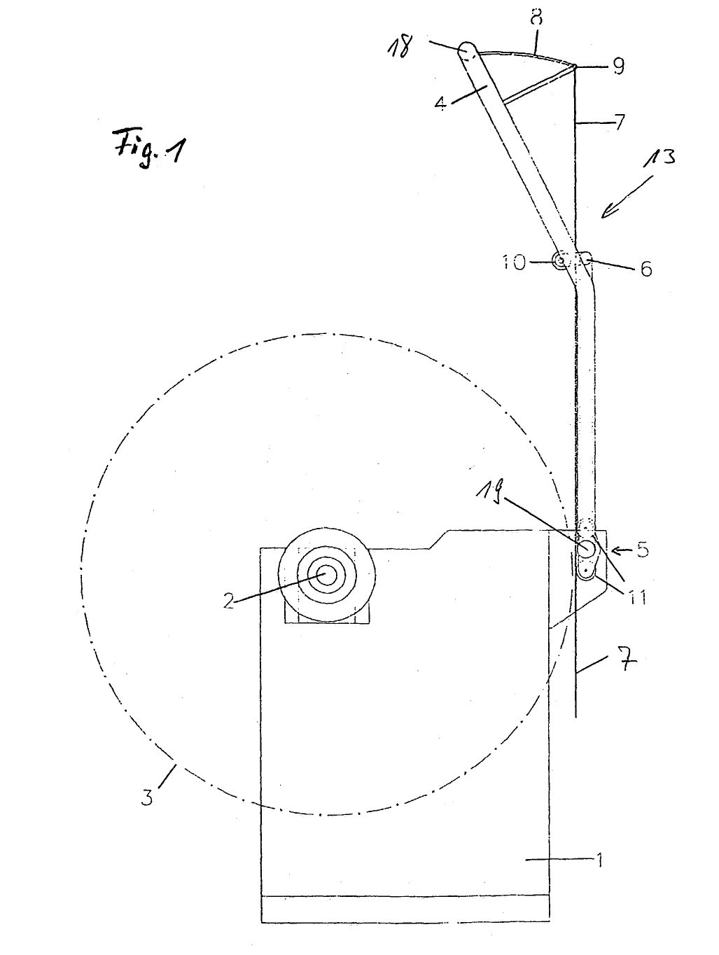

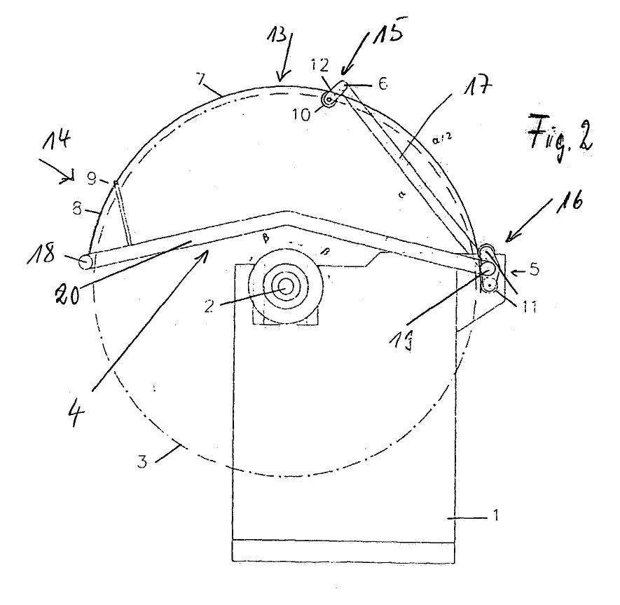

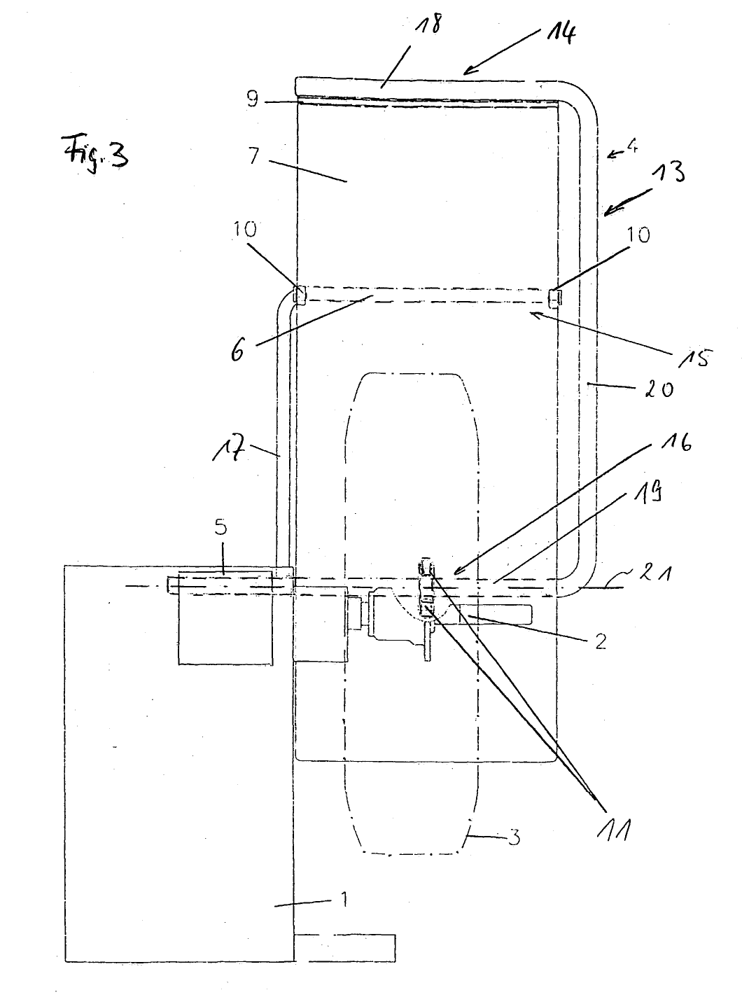

Looking generally at the Figures showing a wheel balancing machine including a wheel guard arrangement according to the invention, reference numeral 1 denotes a housing of the balancing machine and reference numeral 2 denotes a main shaft which is supported rotatably by the housing 1. To carry out an unbalance measurement operation in respect of a motor vehicle wheel as indicated at 3 and the periphery of which is shown in dash-dotted lines, the wheel 3 is fixed on the shaft 2 by means of a suitable centering arrangement. The wheel is then rotated to carry out an unbalance measuring run. During the measuring run, to protect the operator and the area around the machine, an arcuate wheel guard member 13 of the wheel guard arrangement is moved from an open position as shown in FIGS. 1 and 3 into a closed position as shown in FIG. 2.

It will be seen from FIGS. 1 and 3 that, in the open position, the wheel guard member 13 will accordingly assume a substantially vertical position while FIG. 2 shows that in the closed position the wheel guard member 13 is arranged substantially horizontally. In the open position this arrangement ensures free access to the shaft 2 of the balancing machine and to a wheel 3 when carried on the shaft 2. In the closed position as shown in FIG. 2, the part of the wheel 3 which is above the shaft 2 of the balancing machine is substantially covered over by the wheel guard member 13.

In the illustrated embodiment the wheel guard member 13 includes a flexurally elastic plate 7 which is in a flat or planar configuration in the open position as shown in FIGS. 1 and 3 and which is deformed into an arcuate configuration, in particular substantially a circular arc, when it is pivoted into the closed position illustrated in FIG. 2.

The flexurally elastic plate 7 is supported and guided by a pivotable frame 4. The pivotal frame 4 is mounted pivotably in a mounting device 5 at the rear of the machine housing 1, being therefore at the right-hand side in FIGS. 1 and 2. The frame 4 has a frame member which is indicated at 20 in FIGS. 2 and 3 and which extends substantially perpendicularly to a pivot axis indicated at 21 in FIG. 3 of the mounting device 5 and the longitudinal direction of the plate 7. As FIG. 2 clearly shows the frame member 20 is of a slightly bent or angled configuration.

At the rearward end which is at the right-hand side in FIGS. 1 and 2 the frame 4 has a transverse frame member 19 which extends transversely with respect to the longitudinal direction of the plate 7 and which is supported pivotably about the pivot axis 21 in the mounting device 5. At the front end, towards the left in FIGS. 1 and 2, the frame 4 has a further transverse frame member 18 extending transversely with respect to the longitudinal direction of the plate 7. As can be seen in particular from FIG. 3 the frame members 18, 19 extend substantially parallel to the main shaft 2 of the balancing machine.

A front support location 14 and a rear support location 16 for the flexurally elastic plate 7 which is of a substantially rectangular configuration are formed at the front and rear ends respectively of the frame 4. At the front support location 14 the flexurally elastic plate 7 is fixedly connected to the frame 4. For that purpose, a fixed wheel guard portion 8 which can also be of a pre-shaped arcuate configuration is fixed to the frame 4. The fixed wheel guard portion 8 has a fixing location 9 which extends transversely with respect to the longitudinal direction of the plate 7 and in which the front end of the plate 7 is fixed to the wheel guard portion 8. The wheel guard portion 8 may also have substantially triangular lateral guard pieces to afford side protection at that location.

At the rear end of the frame 4, towards the right therefore in FIGS. 1 and 2, the flexurally elastic plate 7 is mounted movably with respect to the frame and in particular with respect to the rear frame member 19. Rollers 11 are provided for that purpose, to afford a movable mounting involving a low level of friction. In the illustrated embodiment a pair of rollers 11 is disposed on the longitudinal center line of the rectangular plate 7, as can be most clearly seen from FIG. 3. For that purpose the pair of rollers 11 can be mounted on the rear, transversely extending frame member 19, the frame member 19 being rotatable with respect to the roller mounting. It will be noted that, instead of a centrally arranged pair of rollers 19, it is also possible to provide two pairs of rollers in the region of the respective side edges of the plate 7.

It will be seen from the views in the drawings that, when the guide member 13 is pivoted from the open position of FIG. 1 into the closed position of FIG. 2, the rearward part of the plate 7 is displaced along the rear support location 16 which is essentially formed by the rollers 11 on the frame 4. The rollers 11 forming the support location 16 bear against the outside surface of the flexurally elastic plate 7.

In order to put the flexurally elastic plate 7 into the arcuate shape illustrated in FIG. 2 when it is moved from the open position of FIG. 1 into the closed position of FIG. 2, the wheel guard arrangement has a further central support location 15 which acts on the plate 7 substantially at the center thereof. In the illustrated embodiment that support location 15 is disposed at the free end of a lever 17 which forms a support device and which is mounted to the machine housing 1 pivotably about the pivot axis 21. The lever 17 however may also be mounted pivotably about a separate pivot axis provided at a suitable location on the machine housing 1.

At its free front end the lever 17 has a support loop 6 extending transversely with respect to the longitudinal direction of the plate 7. The position of the loop 6 in relation to the plate 7 can be clearly seen from FIG. 3. The support loop 6 extends parallel to the transversely extending frame members 18 and 19.

To provide for supporting the central region of the plate 7 with a low level of friction, mounted on carrier arms indicated at 12 in FIG. 2 are rollers 10 over which the plate 7 is movably guided. It will be appreciated that, instead of the rollers, it is also possible to provide a straight deflection surface on the support loop 6, over which the central part of the flexurally elastic plate 7 is guided with a low level of friction. The rollers 10 or the central support location 15 formed in some other fashion bear against the inside surface of the central region of the plate 7, as can be clearly seen from FIG. 2.

The angle of pivotal movement of the lever 17 is less than the angle of pivotal movement of the frame 4 when the wheel guide member 13 is moved between the open and the closed positions. When the frame 4 is pivoted from the open position of FIG. 1 into the closed position of FIG. 2, the lever 17 is also pivoted therewith. In that case, a suitable transmission can be operate between the frame 4 and the lever 17 or further pivotal movement of the lever 17 beyond the required position can be prevented by an abutment. The lever 17 is stopped in the raised position shown in FIG. 2 so that the three support locations, namely the front support location 14, the rear support location 16 and the central support location 15, are disposed at the corners of a triangle. It will be seen that, by virtue of the reduced pivotal movement of the lever 17 such that it stops in the position shown in FIG. 2, the central support location 15 forms an upper support location bearing against the inward surface of the plate 7. By virtue of its flexural elasticity the plate 7 assumes the arcuate shape shown in FIG. 2 and extends around the upwardly disposed part of the periphery of the motor vehicle wheel 3 which is fixed to the main shaft 2.

In the pivotal movement between the opened and closed positions the plate 7 moves over the deflection or support location 15 bearing against the inward surface of the plate 7 and the support or deflection location 16 which bears against the outer surface of the plate 7. It has already been mentioned that in the illustrated embodiment the support locations are formed by the rollers 10 and 11 but it will be appreciated that in place of the rollers it is also possible to use other low-friction deflection locations, for example rods or bars.

Instead of the lever 17 being mounted pivotably as illustrated, it can also be provided fixedly as a support member on the machine housing 1 so as to provide a stationary support or deflection location 15 which in the central region of the longitudinal extent of the plate 7 bears against the inward side of the plate 7.

Preferably, the lever 17 is disposed beside the one longitudinal edge of the plate 7, in particular at the inward side thereof, being the side at the left in FIG. 3. Preferably also the longitudinally extending frame portion 20 of the frame 4 extends beside the other longitudinal edge of the plate 7, at the outward side, being therefore the right-hand side in FIG. 3. That ensures that the arcuate wheel guard member 13 can open and close unimpededly, even when the lever 17 involves a stationary arrangement.

In addition, between the rear support location 16 which is disposed approximately at the height of the shaft 2 of the balancing machine and the upward support location 15 which is at an arcuate distance from the rear support location 16 of between approximately 70° and 90°, it is possible to provide further stationary support locations or a continuous stationary guide structure, similarly to the stationary guide structure disclosed in DE 100 12 356 A1 to which reference is made for the incorporation of the disclosure thereof herein. That guide structure or the additional support locations referred to are so arranged that they are adapted to the desired arcuate shape which the flexurally elastic plate 7 is intended to exhibit in that region. In this embodiment the outwardly disposed frame portion 20 is preferably in the form of a telescopic bar so that in this embodiment, when the plate 7 is moved into the opened configuration, it is displaced at its rearward end downwardly from the rear support location 16. In so doing it is moved possibly by an additional guide structure or automatically into the flat or planar configuration which it assumes in the substantially vertically positioned state.

When the plate 7 is moved back from the closed position shown in FIG. 2 into the open position shown in FIGS. 1 and 3, the plate is automatically restored to its flat or planar configuration by virtue of the resilient return force which is stored or acting in the material of the plate. When the plate 7 is in its flat vertical condition there is no need for any additional substantial space behind the machine housing 1.

It will be appreciated that the plate 7 comprises a suitable flexurally elastic material, for example metal or plastic material, of suitable thickness. It is however also possible to use a plate consisting of two or more layers, wherein at least one layer serves to catch pieces which fly off the wheel as it rotates, and is of the rectangular shape shown in the drawing. The at least one further layer can preferably serve for the dimensioning of local flexural moments along the longitudinal extent of the plate. It is possible in that way to provide for the desired arcuate shape for the plate 7 in the closed position of the wheel guard arrangement. Preferably the plate 7 in the closed position is in the shape of a circular arc.

It will be appreciated that the above-described embodiment has been set forth solely by way of example and illustration of the principles of the present invention and that various modifications and alterations may be made therein without thereby departing from the spirit and scope of the invention.

What is claimed is

1. A wheel guard arrangement of a wheel balancing machine including a housing and a wheel balancing shaft, the wheel guard arrangement comprising
a wheel guard member,
and a mounting device for mounting the wheel guard member on the housing of the balancing machine movably between an open position in which the wheel guard member is arranged substantially vertically and a closed position in which the wheel guard member is arranged in a substantially horizontal arrangement over the shaft of the balancing machine,
wherein the wheel guard member includes a frame supported on the machine housing and movable between the open and the closed positions and a flexurally elastic plate guided by the frame, the flexurally elastic plate in the open position being of a substantially flat shape and in the closed position being deformed in an at least substantially arcuate configuration.

2. A wheel guard arrangement as set forth in claim 1 including
at least three support locations for supporting the plate in its longitudinal extent on the machine housing.

3. A wheel guard arrangement as set forth in claim 1
wherein the flexurally elastic plate is mounted to the machine housing by means of the frame.

4. A wheel guard arrangement as set forth in claim 1 including
means mounting the frame pivotably to the machine housing.

5. A wheel guard arrangement as set forth in claim 2 including
means fixedly connecting the flexurally elastic plate to the frame at at least one support location and
means supporting the plate on the frame movably with respect to the frame at the at least two other support locations.

6. A wheel guard arrangement as set forth claim 1
wherein the flexurally elastic plate is of a flexurally elastic nature for resilient return from the arcuate shape into the flat shape.

7. A wheel guard arrangement as set forth in claim 1
wherein in the closed position the flexurally elastic plate is approximately in the shape of a circular arc.

8. A wheel guard arrangement as set forth in claim 2
wherein the plate has first and second ends and a central region and the support locations on the plate are arranged at least in the region of the ends of the plate and substantially in the central region of the plate.

9. A wheel guard arrangement as set forth in claim 2
wherein a said support location is provided at the end of the plate in the region of the mounting device.

10. A wheel guard arrangement as set forth in claim 9 including
means guiding the plate movably with respect to the frame at the support location in the region of the mounting device.

11. A wheel guard arrangement as set forth in claim 8 including
means guiding the plate in the central region of the longitudinal extent thereof movably at the support location disposed there.

12. A wheel guard arrangement as set forth in claim 11
wherein the support location arranged substantially in the central region of the plate has at least one support element at which the plate is movably guided.

13. A wheel guard arrangement as set forth in claim 2
wherein the support location substantially in the central region of the plate is arranged above the shaft of the balancing machine in said closed position.

14. A wheel guard arrangement as set forth in claim 2
wherein the support locations at the ends of the flexurally elastic plate in said closed position are arranged substantially at the height of the shaft of the balancing machine.

15. A wheel guard arrangement as set forth in claim 2
wherein the support locations at the ends of the flexurally elastic plate in said closed position are arranged slightly above the height of the shaft of the balancing machine.

16. A wheel guard arrangement as set forth in claim 2 including
a support device mounted in use pivotably to the machine housing
wherein the support location substantially in the central region of the plate is arranged at said support device.

17. A wheel guard arrangement as set forth in claim 2 including
a support device mounted in use stationarily to the machine housing
wherein the support location substantially in the central region of the plate is arranged at said support device.

18. A wheel guard arrangement as set forth in claim 16
wherein the support device is a pivotable lever which is arranged in the closed position substantially parallel to the frame.

19. A wheel guard arrangement as set forth in claim 18
wherein said lever, upon pivotal movement out of said open position into said closed position, has a smaller angle of pivotal movement than the frame.

20. A wheel guard arrangement as set forth in claim 1
wherein the flexurally elastic plate has an end in opposite relationship to the mounting device fixedly connected to the frame.

21. A wheel guard arrangement as set forth in claim 1
wherein the flexurally elastic plate is of a multi-layer nature.

22. A wheel guard arrangement as set forth in claim 1
wherein the frame includes frame members extending transversely with respect to the longitudinal direction of the plate in the region of the ends of the flexurally elastic plate.

23. A wheel guard arrangement as set forth in claim 16
wherein at the end of the plate towards the mounting device, the support device bears against the outside of the plate and in the central region of the plate the support device thereat bears against the inside of the plate.

24. A wheel guard arrangement as set forth in claim 17
wherein at the end of the plate towards the mounting device, the support device bears against the outside of the plate and in the central region of the plate the support device thereat bears against the inside of the plate.

25. In a wheel balancing machine including a housing, a wheel mounting shaft and means rotatably supporting the shaft in the housing, a wheel guard arrangement comprising
a wheel guard member,
a mounting device for mounting the wheel guard member on the housing of the balancing machine movably between an open position in which the wheel guard member is arranged substantially vertically and a closed position in which the wheel guard member is arranged in a substantially horizontal arrangement over the shaft of the balancing machine,
wherein the wheel guard member includes a frame supported on the machine housing and movable between the open and the closed positions and a flexurally elastic plate guided by the frame, the flexurally elastic plate in the open position being of a substantially flat shape and in the closed position being deformed in an at least substantially arcuate configuration, and
at least three support locations for supporting the plate in its longitudinal extent on the machine housing.
